(19) United States
(12) Patent Application Publication
(10) Pub. No.: US 2025/0201446 A1
(43) Pub. Date: Jun. 19, 2025

(54) COATING FOR PASSIVE HEAT DISSIPATION FOR OVERHEAD CONDUCTORS AND CABLES

(71) Applicant: Magnekon, S.A. de C.V., Nuevo Leon (MX)

(72) Inventors: Juan Carlos MORALES HUERTA, Nuevo Leon (MX); Edgar Alberto DUARTE PEÑA, Nuevo Leon (MX); Francisco DÍAZ CAMACHO, Nuevo Leon (MX)

(73) Assignee: Magnekon, S.A. de C.V., Nuevo Leon (MX)

(21) Appl. No.: 18/539,898

(22) Filed: Dec. 14, 2023

(51) Int. Cl. H01B 7/42; B05D 1/18; C08K 3/30; C09D 1/02; C09D 7/40; C09D 7/45; C09D 7/61; C09D 7/80; C09D 175/04; C09K 5/14

(52) U.S. Cl. CPC H01B 7/421; B05D 1/18; C09D 1/02; C09D 7/45; C09D 7/61; C09D 7/67; C09D 7/68; C09D 7/80; C09D 175/04; C09K 5/14; C08K 2003/3045; C08K 2201/001; C08K 2201/006; C08K 2201/011

(57) ABSTRACT

A “Passive Radiative Coating” (PRC) is designed to dissipate heat generated mainly by solar radiation, intended for use in the manufacture of overhead conductors and cables. Additionally, this coating can dissipate heat produced by the conductors themselves, known as the Joule effect, providing environmental protection and significantly improving heat dissipation capacity. The PRC is composed of at least one filler, at least one binder, and at least one surfactant. In particular, the use of calcium carbonate and/or barium sulfate as fillers, and epoxy resins, alkyd varnishes, polyurethane dispersions, casting resins, silicone-based varnishes, and sodium silicate as binders are highlighted. The surfactant is used to stabilize the mixture and acts as a stabilization additive.

### FIELD OF THE INVENTION

The present invention relates to a “coating for Passive Heat Dissipation” designed for applications in overhead conductors and cables. The coating according to the present invention provides an effective solution to reduce heat accumulation, both from solar sources and Joule effect, in applications related to overhead conductors and cables. The coating according to the present invention is a composition comprising specific fillers, binders, and surfactants, achieving a significant and advantageous decrease in the temperature of the target conductor. Additionally, the present invention brings notable advantages in terms of thermal efficiency and protection for conductors and cables in various applications.

### BACKGROUND OF THE INVENTION

In the context of electrical engineering and telecommunications, it is evident that the efficiency and longevity of conductors are of fundamental importance to ensure the proper functioning of electrical power transmission networks and communication infrastructures. However, a critical technical challenge arises from the heat accumulation in conductors, mainly caused by two predominant sources of heat: solar radiation and the Joule effect induced by electrical current. Conductors, particularly overhead cables operating in outdoor environments exposed to solar radiation, experience a considerable temperature increase. This thermal rise results in a significant decrease in their ability to transmit electrical power and, consequently, directly affects their performance. Moreover, as an expert in the field may know, the flow of electrical current through these conductors generates additional heat, known as the Joule effect, aggravating the heat accumulation problem. The combination of solar radiation and the Joule effect accelerates the deterioration process of the conductors, leading to a substantial reduction in the efficiency of electrical power transmission and a compromise in their mechanical integrity. This technical challenge is particularly relevant in critical applications where the integrity of conductors is essential, including electrical power transmission systems supplying electricity to communities and businesses, as well as global telecommunication networks. The reduction of the lifespan of conductors due to excess heat results in costly expenses associated with replacements and maintenance, in addition to a negative impact on the reliability and stability of electrical and communication networks. In the search for solutions to this technical problem, it is relevant to consider existing background in the field of coatings and thermal control. Such is the case of U.S. Patent No. U.S. Pat. No. 10,100,203 B2, published on Jul. 20, 2017, which describes a curable coating composition using silicates, phosphates, and metal oxides to regulate the temperature of objects to which the coating is applied. However, while the '203 US patent focuses on coatings that regulate the temperature of objects, it does not specifically address the challenge of conductors and cables used in electrical and telecommunications applications. Therefore, it is clear that coating compositions according to the teachings of the '203 US patent may be effective for certain purposes and/or applications but lack a comprehensive approach to heat dissipation in conductors exposed to solar radiation and Joule effect, particularly considering the characteristics derived from the nature of an electrical conductor or cable in the operational and environmental conditions previously outlined in this document. This limitation is evident when considering the need to mitigate heat accumulation in overhead conductors and cables used in electrical power and communication networks. Thermal control coatings described in the '203 US patent do not address the direct interaction of conductors with these heat sources, resulting in a significant reduction in the efficiency of electrical power transmission and premature deterioration of the conductors. Therefore, it is clear that there is an unmet need for a comprehensive solution to the technical problem we have discussed, including effective thermal regulation in conductors and overhead cables used in critical electrical power and telecommunication applications. Additionally, the invention disclosed in U.S. Patent No. U.S. Pat. No. 11,091,394 B2, published on Mar. 25, 2021, is known, describing a composition intended to coat electronic components for electrical insulation and heat dissipation purposes. The composition claimed in said '394 US patent is based on a combination of aqueous phosphoric acid or hydrogen phosphate, compounds of oxides, hydroxides, and hydrates of magnesium, calcium, iron, zinc, and copper, as well as a filler including a variety of materials such as glass, calcium sulfate, silicates, aluminates, and others. It also contains urea in certain proportions. One of ordinary skill in the field to which this invention belongs may note that, while the composition of the '394 US patent presents approaches applicable to electrical insulation and heat dissipation in electronic components, it lacks specific consideration of the issues related to conductors and cables used in critical electrical power and telecommunication applications. The composition (from the '394 US patent) does not address the critical technical challenge outlined throughout this application, namely, the heat accumulation in conductors, mainly caused by solar radiation and the Joule effect, resulting in a significant decrease in the efficiency of electrical power transmission and deterioration in the mechanical integrity of conductors given the characteristics derived from the nature of an electrical conductor or cable in the operational and environmental conditions previously outlined in this document. Similar to the teachings of the '203 US patent, which focuses on thermal control coatings, the '394 US patent does not provide effective solutions to the specific thermal problem faced by conductors used in electrical power transmission networks and telecommunications. Therefore, there is again an unmet need for a comprehensive solution that effectively addresses this technical problem, improving thermal efficiency and prolonging the lifespan of conductors in critical applications, thereby contributing to the stability and reliability of global electrical and communication infrastructures. On the other hand, U.S. Patent No. U.S. Pat. No. 11,655,375 B2 describes a coated overhead conductor configured to allow the conductor, to which the solution is applied, to operate at lower temperatures. According to the teachings of said '375 US patent, the coating is based on a composition that includes a filler, a crosslinking agent, an emissivity agent, and a silicate binder.

Once again, just as in the cases of the previously cited U.S. patents, patent US '375 does not address the technical problem of interest. The composition of patent US '375 only has the capacity to allow conductors to operate at lower temperatures. Therefore, it is evident to a person of ordinary skill in the art that the teachings of this patent do not adequately address the technical problem of interest, namely, the heat accumulation in conductors due to sources such as solar radiation and the Joule effect, as highlighted earlier. Once again, currently known and/or available technology does not offer a comprehensive solution to the specific technical problem related to the decrease in efficiency and lifespan of conductors in critical electrical power and telecommunication applications due to excess heat.

Furthermore, as deduced from the teachings of patent US '375, the mentioned composition involves the use of fillers and a silicate binder but does not provide an effective solution to address heat accumulation in conductors and cables. It does not offer a strategy to efficiently regulate temperature to mitigate the detrimental effects of solar radiation and the Joule effect. Therefore, the need remains for a comprehensive solution that improves thermal efficiency and prolongs the lifespan of conductors in critical applications, negatively impacting the stability and reliability of electrical and communication infrastructures.

Additionally, within the state of the art, U.S. Patent No. U.S. Pat. No. 6,761,934 B2, published on Jun. 26, 2003, is known, describing a process aimed at creating a deposit on the surface of metallic or conductive materials. The process according to the previously mentioned US '934 patent involves applying a coating or film containing minerals to a metallic surface that can be made of various materials, such as copper, nickel, tin, iron, zinc, aluminum, magnesium, stainless steel, and alloys of these. The process of the US '934 patent also uses a medium containing water, colloidal silica, and at least one silicate, characterized by having a basic pH and a temperature above approximately 50° C.

While the invention described in the US '934 patent is directed towards creating a protective coating on the surface of metallic materials, its main focus does not address the critical technical problem discussed throughout this application. Clearly, the teachings of the US '934 patent show a protective coating that does not provide a comprehensive solution to regulate the temperature of conductors exposed to heat sources such as solar radiation and the Joule effect. Once again, there is a clear lack of alternatives to address the technical problem of interest, namely, an efficient technology that prevents and/or avoids the decrease in efficiency and lifespan of conductors in critical electrical power and telecommunication applications due to excess heat. Evidently, the use of technologies like that disclosed in the US '934 patent results in costly expenses associated with replacements and maintenance, in addition to a negative impact on the reliability and stability of electrical and communication networks. In this regard, the US '934 patent does not satisfy the need for a comprehensive solution that improves thermal efficiency and prolongs the lifespan of conductors in critical applications.

Similarly, within the state of the art, the international patent application publication No. WO2007034248A1, published on Sep. 18, 2006, is known, disclosing an invention focused on an overhead conductor with a surface treatment. The treatment referred to, according to the teachings of document WO2007034248A1, involves modifying the surface of the conductor through a coating, a chemical process, and/or preparation of the external insulation layer (in the case of an insulated conductor). The objective of the treatment in document WO2007034248A1 is to achieve a conductor with an emissivity coefficient in the operating temperature range equal to or greater than 0.7, while the solar absorption coefficient is equal to or less than 0.3.

Now, based on the teachings of document WO2007034248A1, it can be noted that the disclosed invention partially addresses the temperature regulation in overhead conductors by attempting to reduce solar heat absorption and promote heat emission. However, this proposal has significant deficiencies, including those related to the materials used, the methodology of coating generation, and application on the conductor. Furthermore, the performance related to thermal dissipation is also lacking. Therefore, the invention claimed in document WO2007034248A1 does not offer a comprehensive solution to address the fundamental technical problem arising from heat accumulation in conductors, mainly caused by solar radiation and the Joule effect induced by electrical current.

Based on the above and derived from the combined teachings of the technology available within the state of the art, there is an evident need to provide a complete, full, efficient, simple, and practical solution that allows managing the internal heat generated by the electrical current present in an electrical conductor or cable. Additionally or collectively, it should be able to manage the heat absorbed by said conductor or cable derived from solar radiation. This is especially crucial when the conductor or cable is critically exposed in environments or settings where such solar radiation is applied or exposed for extended periods, covering the entire radiation exposure from the sun during an average day. Thus, it foresees conditions that limit its effectiveness in critical electrical power and telecommunication applications where heat accumulation is a significant problem.

### SUMMARY OF THE INVENTION

To effectively address the technical problem of interest, the present invention aims to provide a “coating for Passive Heat Dissipation.” In a more specific objective, the present invention provides a coating for passive dissipation, which is configured to specifically address heat accumulation in overhead conductors and cables. In this sense, by ‘addressing heat accumulation,’ it should be understood that the coating according to the present invention is configured to allow efficient and advantageous dissipation of the heat generated in and by the conductor and/or electrical cable. Now, as a person of ordinary skill in the art and the field to which the present invention belongs will understand, ‘allowing efficient and advantageous dissipation of the heat generated in and by the conductor and/or electrical cable’ makes it clear that the present invention allows for efficient distribution of the heat generated, firstly, by the thermal effect resulting from the passage of current through the conductor, known as the Joule Effect, and secondly, the present invention allows for efficient distribution of the heat absorbed through radiation from the immediate environment with which the conductor and/or electrical cable interacts. In general, this heat can come primarily from solar radiation, which directly contacts the surfaces of the conductor/electrical cable.

The foregoing enables, in general, the electrical conduit and/or cable to efficiently and advantageously distribute heat from the previously mentioned sources. This ensures that the electrical conductor/cable remains at a stable average temperature, with this average temperature being an optimal and/or recommended temperature within a safety parameter. This parameter aims to prevent and/or reduce (even completely eliminate) the possibility and/or potential of a reduction in the working efficiency of the electrical conductor/cable. For example, this reduction could involve a decrease in the amount of energy (current) it can carry, and/or even prevent potential partial or total damage, consequently increasing its lifespan. Moreover, it offers an innovative solution that enhances thermal efficiency and extends the lifespan of conductors under solar radiation and Joule effect conditions. As a result, it contributes to higher efficiency and performance in critical electrical power transmission and communication applications, while reducing maintenance costs and enhancing the reliability of electrical and communication infrastructures.

In another objective, the present invention provides a novel method which, as a result of implementing its sequence of steps and/or stages, generates a material, particularly a coating. Once applied to the electrical conductor/cable, this coating has the potential to provide the aforementioned improvements.

### BRIEF DESCRIPTION OF THE DRAWINGS

FIG. 1 illustrates a flowchart depicting a first stage of a methodology for generating a mixture, termed or characterized as a coating, which, once generated, can be applied to an electrical conductor and/or cable. This generates a coated conductor (or coated electrical cable) with advantageously improved heat dissipation properties.

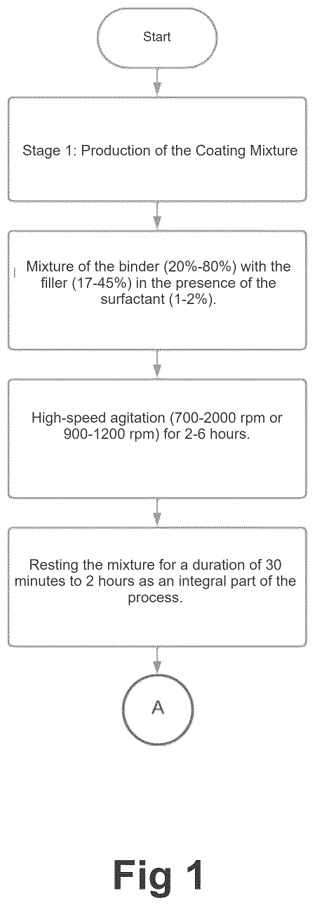

FIG. 2 shows a flowchart illustrating a second stage of a methodology related to the coating process and/or application of the mixture—generated in FIG. 1—to an electrical conductor and/or cable with advantageously improved heat dissipation properties. This application of the coating to the electrical conductor/cable achieves passive dissipation of the heat absorbed and/or generated by it.

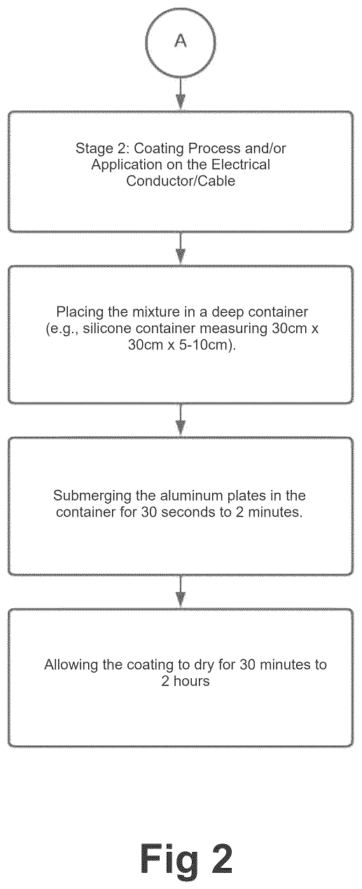

FIG. 3 displays a graph contrasting the temperature of the cable/electrical conductor with respect to the applied voltage. It also compares the temperature variation of an uncoated cable and/or electrical conductor (upper part of the graph) with a coated cable and/or electrical conductor according to the present invention (lower part of the graph).

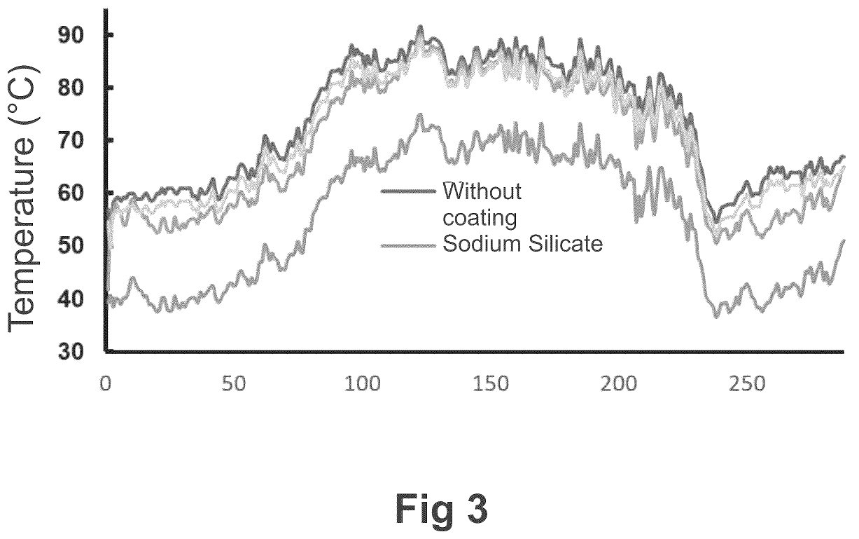

FIG. 4 presents another graph illustrating the variation in the temperature of the cable/electrical conductor throughout the day (24-hour test). The coating according to the present invention was applied to the cable and/or electrical conductor on a micrometric and nanometric scale. The graph shows that the ideal particle size is nanometric.

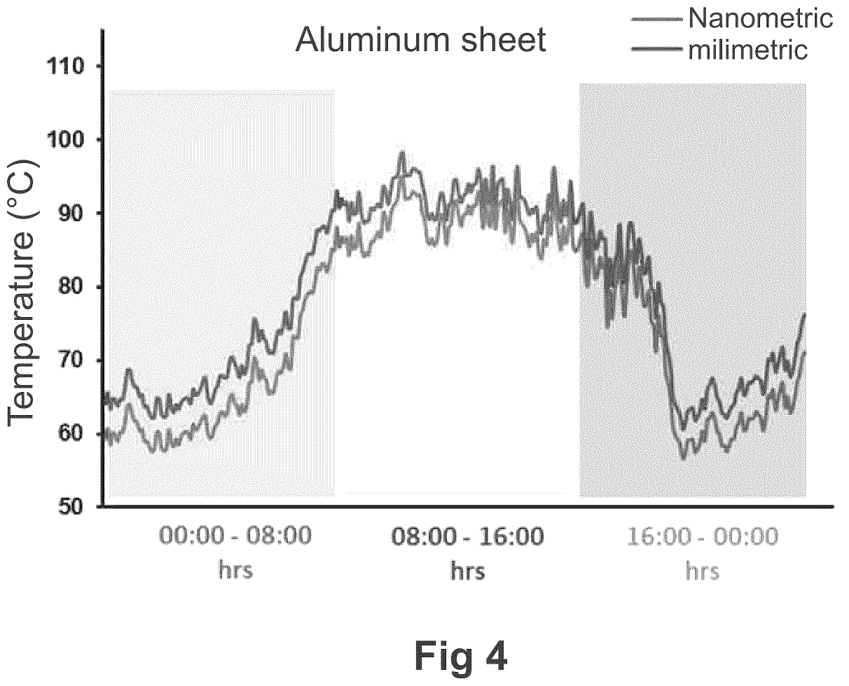

FIGS. 5A-5C show an additional chart where the results of tests conducted with applied voltages of 40 V, 60 V, and 70 V are observed. In these results, it is evident that the maximum temperature delta is 30° C. from the temperature without coating compared to the temperature with coating (line in the lower portion of the graph).

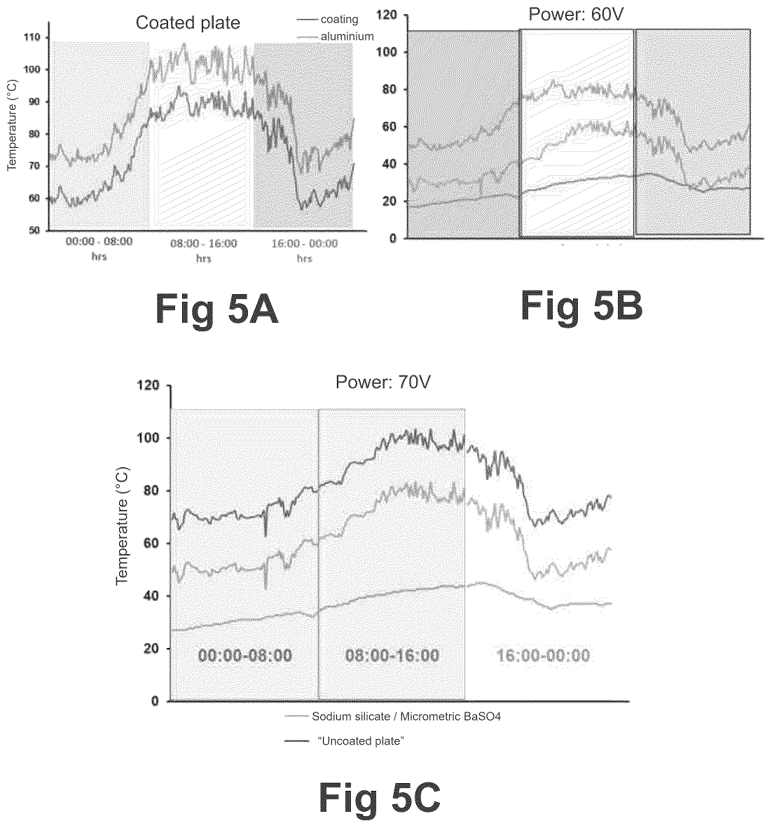

FIGS. 6A-6F display photographs taken, firstly, with an ordinary camera (6A-6C) and photographs taken with a thermal camera (6D-6F) of uncoated and coated plates using the coating according to the present invention, both on a micrometric and nanometric scale, respectively. The results show that the uncoated plate tends to be at a higher temperature compared to the coated ones, and likewise, the plate coated with the coating according to the present invention in a nanometric manner decreases the temperature more significantly (exhibiting greater thermal dissipation).

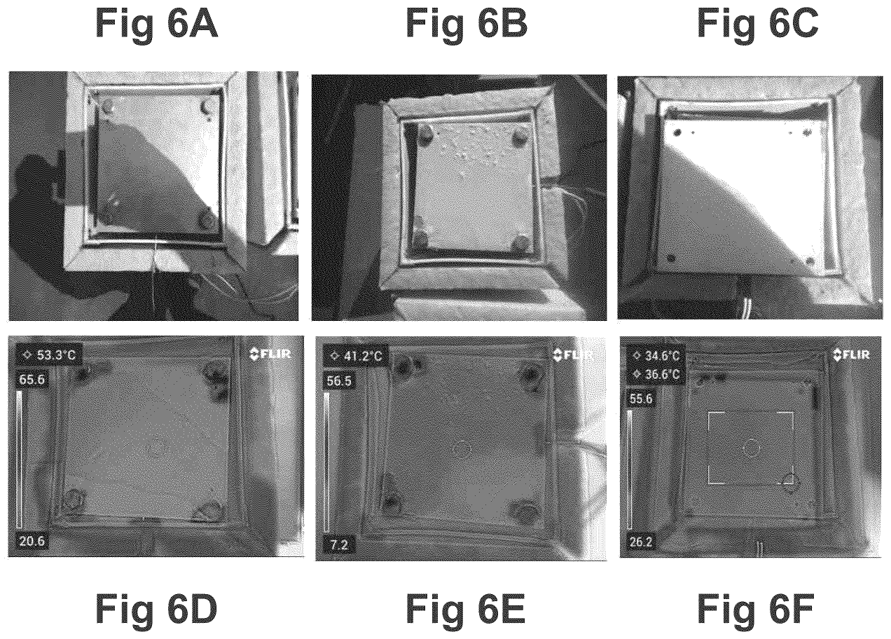

FIG. 7 illustrates tests on aluminum wire, showing a specially designed device for this test where electric current was passed at different amperages, causing the aluminum wire to heat up. Half of the wire was coated with the resin and/or mixture according to the present invention, and the other half remained uncoated. After the test, it was observed that at higher amperages and, therefore, higher temperatures, the portion coated with the mixture according to the present invention reduced its temperature by approximately 14° C., maintaining the trend observed in the plates shown in FIGS. 6A-6F.

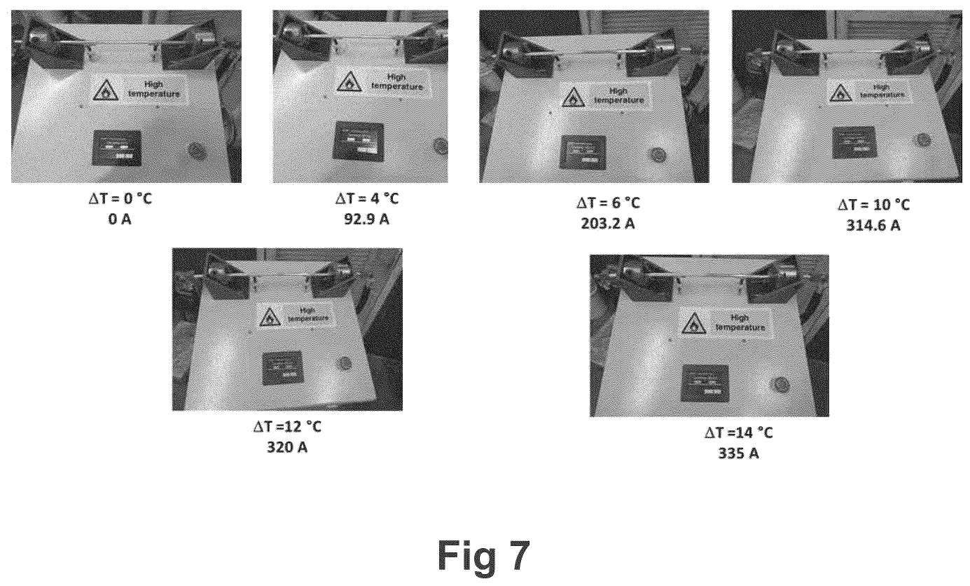

### DETAILED DESCRIPTION OF THE INVENTION

Some aspects of the present invention will now be described in more detail with reference to the attached drawings, showing some embodiments and advantages of the present invention. It will be apparent to one skilled in the art that various embodiments of the invention may be expressed in different forms and should not be interpreted as limited to the embodiments described herein; rather, these exemplary embodiments are provided to make the invention clear and complete, conveying the full scope of the invention to those skilled in the art. For example, unless otherwise indicated, something described as first, second, or the like should not be interpreted as a particular order. As used in the description and in the appended claims, singular forms “a, one,” “an,” “the,” include plural referents unless the context clearly indicates otherwise.

Different aspects of the present invention pertain to a coating for passive heat dissipation or passive heat dissipation. In the context of the present invention, ‘passive dissipation’ should be understood as the ability of a system, device, or material to release heat naturally without requiring active components, such as fans or cooling systems, to remove heat. Instead of relying on an active cooling system that consumes energy, passive heat dissipation is based on the conduction, convection, and radiation of heat through components or materials designed to facilitate the transfer of heat to the surrounding environment.

In the context of the present invention, ‘passive heat dissipation’ implies and/or applies to a coating-type material and a method for generating the same, allowing the heat generated in the conductors/electrical cable to dissipate naturally, preferably through thermal radiation and convection of surrounding air. The above ensures that, once applied, the coating resulting from the present invention has a superior and advantageous thermal dissipation factor compared to what is known in the prior art. With this, a person of ordinary skill in the art, after a holistic reading of the present invention, will understand that the generated coating, as described in this application, has the capacity to, once applied to any type of cable and/or, in general, an electrical conductor, efficiently transfer heat from the cable or electrical conductor—either by Joule effect, i.e., due to the passage of electrical energy through it, combined or isolated with the heat potentially absorbed by the environment to which said cable and/or electrical conductor is exposed.

Likewise, as will become clear upon reading this application, the coating generated according to the present invention allows for advantageous and efficient thermal transfer based on, firstly, the composition and percentages of each of the elements it comprises. This is combined with the particle size of the coating, which the inventor has advantageously found to be, when in a nanometric particle size, more advantageous in terms of higher conductivity/thermal dissipation compared to other particle sizes. This outcome is a result of the methodology provided by the inventor.

The method and coating generated by this method, according to the present invention, are designed to prevent excessive temperature rise in conductors and, therefore, contribute to maintaining their efficient operation and mechanical integrity over time. Once the coating according to the present invention is applied, it is configured—and has proven—to significantly and efficiently elevate the coefficient of thermal transfer. This, in turn, allows for effective dissipation of the present heat and/or heat interacting with the cable and/or electrical conductor to which the coating is applied. With this improvement in the thermal dissipation coefficient, the cable and/or electrical conductor will not retain or be exposed to an excessive amount of energy—nor to a specific amount of energy for an extended period. Consequently, optimal temperature management leads to an improvement in the average lifespan of the cable/electrical conductor.

In particular, the coating according to the present invention generally comprises or makes use of recycled composite materials (PCR), incorporating three fundamental raw materials that play an essential role in its formulation and final properties.

In one embodiment, the coating may include at least one filler, configured as a reinforcing component. The filler may be a high thermal conductivity filler, such as any selected from the group comprising Calcium Carbonate, Barium Sulfate, Aluminum Nitride, Boron Nitride, Beryllium Oxide, or combinations thereof.

According to the present invention, the filler may be present in the coating in a range from 10% to 70%; more particularly, the filler may be present in the coating in a range from 15% to 50%.

Additionally, in one embodiment, the coating according to the present invention may include at least one binder. The binder in the coating serves to consolidate the mixture of at least one filler with the rest of the components described throughout this application, acting as a binding element between the different components forming the coating.

In one embodiment, the selection of binders is diverse and may be chosen from any selected from the group comprising liquid epoxy resins with an EEW range of 100 to 300, alkyd varnishes, unsaturated polyester base, polyurethane dispersions, such as water-based and solvent-based, casting resins, phenolic urethane base, phenol-formaldehyde, furan-based, among others, silicon-based and/or sodium silicate varnishes, combinations thereof, and the like.

In one embodiment, the binder, also referred to as the binder, may be present in a range from 20% to 80%; in another embodiment, the binder may be present in the coating according to the present invention in a range from 30% to 60%.

On the other hand, the binder, according to one embodiment of the present invention, may include and/or be composed of a solvent, in a range from 40% to 90%; more particularly, the binder may include and/or be composed of a solvent in a range from 60% to 85%.

The solvent, according to the present invention, may be an organic solvent or water.

Additionally, the binder, according to one embodiment of the present invention, may include and/or be composed of an inorganic resin, in a range from 5% to 30%; more particularly, the binder may be composed of an inorganic resin in a range from 15% to 25%.

In one embodiment, the inorganic resin present in the binder may be sodium silicate or a polyurethane.

According to another embodiment, the coating according to the present invention further comprises a surfactant, which may be present in a range from 0.1% to 10%; more specifically, the surfactant present in the coating according to the present invention may be in a range from 0.5% to 3%.

This surfactant, in the present invention, is configured to stabilize the resulting mixture, advantageously ensuring a uniform dispersion of the components integrated into the mixture, as described throughout this application. This achieves obtaining homogeneous properties in the final compound.

Likewise, the coating according to the present invention may further comprise an anti-settling agent, which may be present in a range from 0.5% to 10%; more particularly, the anti-settling agent present in the coating according to the present invention may be in a range from 0.5% to 5%.

As will be evident from a holistic reading of this application, each binder selected and incorporated into the coating of the present invention contributes specific properties such as adhesion, durability, and chemical resistance.

Based on the aforementioned, according to one embodiment, the generated coating has, advantageously, a particle size in the order of nanometers; in one embodiment, this particle size may be within the range from 1 to 999 nanometers.

In one embodiment, the particle size may be within the range from 50 nanometers to 500 nanometers.

On the other hand, the present invention refers to an associated methodology to generate, firstly, a mixture termed or characterized as a coating. This coating, as will be evident from a holistic reading of this application, derived from the components, proportions, and/or ranges and, in general, the overall interaction between each of the aforementioned components, generates a coating that, when applied to a conductor and/or electrical cable, can produce a coated conductor (or coated electrical cable) with advantageously improved heat dissipation properties. Particularly, the application of the coating to the electrical conductor/cable achieves passive dissipation of the heat absorbed and/or generated by it.

The aforementioned method is intended to, regardless of the characteristics of the target conductor and/or electrical cable to which it will be applied, form the mixture or coating, from which a product with substantially superior heat dissipation properties is generated.

### Methodology for Coating Generation

According to one embodiment, the manufacturing process of the coating according to the present invention unfolds in two essential stages, each playing a fundamental role in obtaining a high-performance coating for electrical conductors, utilizing the elements and/or components as mentioned throughout this application. The details of both stages are explored below:

Stage 1: Coating Mixture Production In this initial stage, the preparation of the mixture that will constitute the coating according to the present invention takes place. This process is critical to ensuring that the components are uniformly distributed, which, in turn, translates to the effectiveness of the coating. The specific procedures are as follows: A) The first phase involves mixing the Binder from 20% to 80% with the Filler from 17% to 45% in the presence of the Surfactant from 1% to 2%. The combination of these elements is a key step in creating a balanced composition that offers optimal adhesion and heat dissipation. B) The second stage of this phase consists of High-Speed Agitation. This prolonged agitation process is essential for achieving a complete mixture and proper activation of the coating components. In one embodiment, agitation can be performed at a speed ranging from 700 rpm to 2000 rpm; more specifically, agitation can be carried out at a speed ranging from 900 rpm to 1200 rpm. Additionally, the high-speed agitation process, according to the mentioned embodiment, may take place over a period ranging from two to six hours. C) The third and final phase of this stage involves letting the mixture rest for a period of at least thirty minutes and up to two hours. During this resting period, any trapped air bubbles have the opportunity to escape, thereby improving the quality of the mixture.

Stage 2: Coating Process and/or Application on the Electrical Conductor/Cable Once the coating mixture is optimally prepared, based on or following the methodology described in Stage 1, the present invention contemplates a subsequent stage (Stage 2) in which the coating phase of the electrical conductor/cable takes place. The steps involved in this stage are as follows: D) Placing the mixture in a deep container. This container provides the necessary environment for the coating process and ensures that the coating application is uniform and controlled. In one embodiment, the container can be a silicone container with dimensions of 30 cm on each side and 5 to 10 cm in depth. In another embodiment, the container may be made of any other material selected from the group comprising metals such as black steel, stainless steel, alloys, and/or the like; plastics such as Polyethylene (PE), Polypropylene (PP), Polyvinyl chloride (PVC), Polystyrene (PS), Polyethylene terephthalate (PET), Low-density polyethylene (LDPE), High-density polyethylene (HDPE), Polycarbonate (PC), Polymethyl methacrylate (PMMA), High crystallinity polypropylene (HCPP), combinations thereof, and the like, rubber, gum, the like, among others. The mixture is poured into the container until reaching at least 5 cm in depth. On the other hand, when coating wire, a 200 ml graduated cylinder is used, and the mixture is poured into it. E) Placing the cable or electrical conductor on plates; these plates serve as conductive substrates; in one embodiment, the plates can be made of any material selected from the group comprising aluminum, titanium, magnesium, magnesium alloys, titanium alloys, stainless steel, copper alloys, zinc, nickel, nickel alloys, zinc alloys, combinations thereof, and/or the like. In one embodiment, the plates are of sufficient size to be fully immersed in the aforementioned container, which, as mentioned earlier, contains the coating according to the present invention. In this regard, these plates can have any shape selected from the group comprising rectangular prisms, cubes, cylinders, polygons, regular and irregular shapes, and/or combinations thereof; likewise, these plates can have any size ranging from 5 cm to 150 cm. E), submerging the plates in the aforementioned container for a period that can be from 30 seconds to 2 minutes. The plates are immersed in the container containing the coating mixture. This process ensures that the conductor is completely covered by the compound. F), allowing the coating to dry for a period that can be from 30 minutes to 2 hours. During this time, the coating according to the present invention effectively adheres to the target electrical conductor/cable and consolidates, preparing it for use in electrical applications, mainly in applications where the resulting or coated electrical conductor/cable, provided based on the present invention, generates high levels of heat derived from the Joule effect and, collectively, derived from the radiation absorbed by its exposure to the solar radiation of its environment.

### EXAMPLES

Experiments conducted to test this innovation have yielded significant results in terms of heat dissipation, demonstrating its effectiveness in practical conditions. The tests included: ·Photographs with a Thermal Camera, confirming a temperature reduction of up to 30° C. compared to uncoated plates, highlighting a significant decrease in temperature on the plate coated with barium sulfate in its nanometric form. ·Tests on Aluminum Wire, designed to simulate practical situations where electrical conductors may experience heating due to electric current. These tests confirmed a temperature reduction of approximately 14° C. in the coated wire compared to the uncoated wire when the current intensity was increased. ·Experiments on Binder/Filler and Voltage Variation, evaluating the influence of different combinations of binders and fillers on coating performance. These experiments demonstrated that nanometric sodium silicate presented optimal performance, and the coating achieved a maximum temperature decrease of 30° C. compared to uncoated conductors when different voltages were applied. These results strongly support the effectiveness of this invention in dissipating heat from electrical conductors and components, leading to a positive impact on various electrical and electronic applications by improving safety and performance.

Initial Conditions: Application on Plates The binder/filler mixture was placed in a deep container. Aluminum plates were immersed in this container for 1 minute and then left to dry for 1 hour. Tests were conducted with different fillers and binders. Equipment Calibration Initially, the equipment was calibrated by painting the plates with black paint, white paint, and without paint, and at different voltages. Temperatures were measured with the voltage to find the optimal test conditions.

Results Varying the Binder and Filler Tests were conducted at 40 V, using silicon-based varnishes and sodium silicate as binders, using barium sulfate in micrometric and nanometric form as fillers. The results show that nanometric sodium silicate works better than silicon-based varnish, and the appropriate particle size was nanometric.

Results Varying Voltage Tests were conducted at 40 V, 60 V, and 70 V, where it is observed that the maximum temperature delta is 30° C. from the temperature without coating compared to the temperature with coating.

Thermal Camera Photographs Photographs were taken with a thermal camera of the uncoated plates and the other two coated plates using sodium silicate and micrometric and nanometric barium sulfate, respectively. The results show that the uncoated plate tends to be at a higher temperature compared to the coated ones, and likewise, the plate with nanometric barium sulfate is the one that significantly reduces the temperature.

Tests on Aluminum Wire In order to conduct a more realistic test with the phenomena present in the cable, a device was fabricated through which electric current is passed at different amperages, causing the wire to heat up. Half of the wire was coated with the resin containing barium sulfate, and the other half remained bare. It is observed that at higher amperage and therefore higher temperature, the part coated with the mixture decreases its temperature by approximately 14° C., maintaining the trend observed in the plates.

Many modifications and other embodiments of the invention will come to the mind of one skilled in the art to which the invention belongs, who has the benefit of the teachings presented in the foregoing descriptions and associated drawings. Therefore, it should be understood that the invention should not be limited to the specific and exemplary embodiments described but is intended that modifications and other embodiments be included within the scope of the appended claims. Although specific terms are used herein, they are used only in a generic and descriptive sense and not for limiting purposes. It should also be understood that the materials with which the various components of the invention described herein can be made, geometries, dimensions, arrangements, and other elements can vary without departing from the scope and spirit of the invention, and therefore, the embodiments referred to should not be considered limiting.

1. A coating configured for application to an electrical cable and/or conductor, to passively enhance heat dissipation, the coating comprising:
recycled composite materials (PCR);
a filler, the filler being present in said coating in a range from 10 to 70%;
a binder, the binder being present in said coating in a range from 20 to 80%, said binder configured as a binding element between different components present and forming said coating;
a surfactant, the surfactant being present in said coating in a range from 0.1% to 10%;
said surfactant configured to stabilize the mixture, ensuring a uniform dispersion of the components integrated into said mixture; and
an anti-settling agent, the anti-settling agent being present in said coating in a range from 0.5% to 10%;
wherein additionally, said coating has a particle size in the nanometric order, in a size ranging from 50 nanometers to 500 nanometers.

2. The coating according to claim 1, wherein the filler is a filler with high thermal conductivity, such as any selected from the group comprising Calcium Carbonate, Barium Sulfate, Aluminum Nitride, Boron Nitride, Beryllium Oxide, or combinations thereof and/or the like.

3. The coating according to claim 1, wherein the filler is present in the coating in a range from 15% to 50%.

4. The coating according to claim 1, wherein the binder is any selected from the group comprising liquid epoxy resins with an EEW range of 100 to 300, alkyd varnishes, unsaturated polyester-based, polyurethane dispersions, such as water-based and organic solvent-based, casting resins, phenolic urethane, phenol formaldehyde, furan-based, among others, silicon-based varnishes and/or sodium silicate, combinations thereof, and the like.

5. The coating according to claim 1, wherein the binder is present in the coating in a range from 30% to 60%.

6. The coating according to claim 1, wherein the binder comprises a solvent.

7. The coating according to claim 1, wherein the binder comprises an inorganic resin.

8. The coating according to claim 1, wherein the surfactant is present in a range from 0.5% to 3%.

9. The coating according to claim 1, wherein the anti-settling agent is present in a range from 0.5% to 5%.

10. The coating according to claim 6, wherein the solvent is an organic solvent or water and is present in the binder in a range from 40% to 90%

11. The coating according to claim 6, wherein the solvent is an organic solvent or water and is present in the binder in a range from 60% to 85%.

12. The coating according to claim 7, wherein the inorganic resin is sodium silicate or a polyurethane and is present in the binder in a range from 5% to 30%.

13. The coating according to claim 7, wherein the inorganic resin is sodium silicate or a polyurethane and is present in the binder in a range from 15% to 25%.

14. A method for generating the coating according to claim 1, the method comprising the steps of:
i) mixing the Binder with the Filler;
ii) mixing the resulting composition of the binder and filler from step i) with the surfactant;
iii) agitating the resulting mixture from step ii) at a speed ranging from 700 rpm to 2000 rpm; and
iv) letting the agitated mixture from step iii) rest for a period of at least thirty minutes and up to two hours.

15. The method according to claim 14, wherein the surfactant is at a percentage within the range from 1% to 2%.

16. The method according to claim 14, wherein the binder is at a percentage within the range from 20% to 80%.

17. The method according to claim 14, wherein the Filler is at a percentage within the range from 17% to 45%.

18. The method according to claim 14, wherein step iii), that is, the agitation of the mixture, is carried out over a period ranging from two to six hours.

19. A method for applying the coating according to claim 1, on an electrical conductor/cable, the method comprising the steps of:
i) Placing the coating in a container;
ii) Placing the cable and/or electrical conductor to be coated on plates;
iii) Submerging the plates in the container containing the coating;
iv) Removing the plates from the container; and
v) Allowing the embedded coating on the cable/electrical conductor to dry.

20. The method according to claim 19, wherein the container is a container with dimensions of 30 cm on each side and a depth of 5 to 10 cm.

21. The method according to claim 19, wherein the container is made of any material selected from the group comprising metals such as silicone, black steel, stainless steel, alloys, and/or the like; plastics such as Polyethylene (PE), Polypropylene (PP), Polyvinyl Chloride (PVC), Polystyrene (PS), Polyethylene Terephthalate (PET), Low-Density Polyethylene (LDPE), High-Density Polyethylene (HDPE), Polycarbonate (PC), Polymethyl Methacrylate (PMMA), High Crystallinity Polypropylene (HCPP), combinations thereof, and/or the like, rubber, gum, and the like.

22. The method according to claim 19, wherein step i) further includes pouring the mixture into the container to reach at least 5 cm in depth within the container.

23. The method according to claim 19, wherein the plates are made of any material selected from the group comprising aluminum, titanium, magnesium, magnesium alloys, titanium alloys, stainless steel, copper alloys, zinc, nickel, nickel alloys, zinc alloys, combinations thereof, and/or the like.

24. The method according to claim 19, wherein the plates have any shape selected from the group comprising rectangular prisms, cubes, cylinders, polygons, regular and irregular shapes, and/or combinations thereof, and wherein said plates have any size ranging from 5 cm to 150 cm.

25. The method according to claim 19, wherein step iii) further includes submerging the plates in the container for a period of time from 30 seconds to 2 minutes.

26. The method according to claim 19, wherein step v) further includes allowing the coating to dry for a period of time from 30 minutes to 2 hours.
